(19) United States
(12) Patent Application Publication
(10) Pub. No.: US 2025/0329048 A1
(43) Pub. Date: Oct. 23, 2025

(54) SYSTEM AND METHOD FOR JOINT POSE ESTIMATION

(71) Applicant: Samsung Electronics Co., Ltd., Suwon-si (KR)

(72) Inventors: Dongfang ZHAO, San Diego, CA (US); Yangwen LIANG, San Diego, CA (US); Shuangquan WANG, San Diego, CA (US); Kee-Bong SONG, San Diego, CA (US)

(21) Appl. No.: 18/761,280

(22) Filed: Jul. 1, 2024

Related U.S. Application Data
(60) Provisional application No. 63/635,932, filed on Apr. 18, 2024.

(51) Int. Cl. G06T 7/73; G06T 7/55

(52) U.S. Cl. CPC G06T 7/74; G06T 7/55; G06T 2207/20081; G06T 2207/20084; G06T 2207/30196; G06T 2207/30244

(57) ABSTRACT

A system and a method are disclosed for joint pose estimation. In some embodiments, a method includes: generating a first two-dimensional joint position estimate relative to a first camera in a first camera position; generating a second two-dimensional joint position estimate relative to a second camera in a second camera position; generating an estimated three-dimensional joint position, and transmitting the generated three-dimensional joint position estimate. The estimated three-dimensional joint position may be based at least on: a rotation transformation between the first camera position and the second camera position, a generated translational transformation between the first camera position and the second camera position, the first two-dimensional joint position estimate, and the second two-dimensional joint position estimate.

### CROSS-REFERENCE TO RELATED APPLICATION

This application claims the priority benefit under 35 U.S.C. § 119(e) of U.S. Provisional Application No. 63/635,932, filed on Apr. 18, 2024, the disclosure of which is incorporated by reference in its entirety as if fully set forth herein.

### TECHNICAL FIELD

The disclosure generally relates to machine-user interactions. More particularly, the subject matter disclosed herein relates to improvements to hand pose estimation.

### SUMMARY

Applications running on a mobile device such as a laptop or tablet computer or a mobile telephone may interact with a user in various ways, such as allowing the user to type on a keyboard or a virtual keyboard. Such user input mechanisms may have various disadvantages in terms of the rate at which the user may convey information to the mobile device, and the accuracy with which the user may be able to convey information.

To solve this problem joint pose estimation may be used by the mobile device to sense a user's body pose or a user's gestures. While the application may refer to specific use cases, such as “hand pose estimations,” it should be understood that the novel systems and methods discussed herein may refer to estimations of any bodily joints in general. Thus, some instances discussed herein may utilize examples of “hand pose” estimation for illustrative purposes, but it should be understood that the systems and methods may involve any other bodily part (e.g., feet, arms, head, legs, torso, etc.) in a given sense. For example, hand pose estimation involves estimating the position of the hand of the user, including the positions of the thumb and the fingers. The position of the hand may be modeled by a mesh or by the positions of the hand joints, e.g., the positions of the wrist, the thumb joints, and the finger joints.

One issue with the above approach is that many contemporary joint estimation techniques do not provide a proper three-dimensional (3D) estimation position of each joint, and may therefore be of limited use to applications that interact with a user. Further, attempts to estimate 3D joint models are not sufficiently accurate, and/or have memory or resource requirements, such as computation or power consumption, that may not be compatible with mobile devices.

To overcome these issues, systems and methods are described herein for performing full 3D hand pose estimation using novel techniques of combinative position-estimation transformations and generative joint data estimation techniques. Accordingly, the approaches described herein generally improve on previous methods of joint capture and estimation by more accurately capturing and classifying joint movement with reduced resource expenditure. Such advantages are particularly useful on small form factor devices and resource pools, such as mobile devices.

According to an embodiment of the present disclosure, there is provided a method including: generating a first two-dimensional joint position estimate relative to a first camera in a first camera position; generating a second two-dimensional joint position estimate relative to a second camera in a second camera position; generating an estimated three-dimensional joint position based at least on: a rotation transformation between the first camera position and the second camera position, a generated translational transformation between the first camera position and the second camera position, the first two-dimensional joint position estimate, and the second two-dimensional joint position estimate; and transmitting the generated three-dimensional joint position estimate.

In some embodiments, generating the three-dimensional joint position estimate includes generating a depth component of the three-dimensional joint position estimate, the depth component derived from a ratio of a first function of the translational transformation between the first camera position and the second camera position, and a second function of the rotational transformation between the first camera position and the second camera position.

In some embodiments, the first function of the translational transformation between the first camera position and the second camera position is further based on a difference between a first term and a second term, the first term being based on a first component of the second two-dimensional joint position estimate, and the second term being based on a second component of the second two-dimensional joint position estimate.

In some embodiments, the first term is further based on a set of intrinsic parameters of the second camera.

In some embodiments, the first term is further based on a first component of the translational transformation between the first camera position and the second camera position.

In some embodiments, the generating of the first two-dimensional joint position estimate relative to the first camera position includes utilizing a machine learning model, the model including: an object detection backbone; and a joint position estimation and camera parameter estimation block.

In some embodiments, the object detection backbone includes: a convolution block; a Tucker block; and a fused inverted bottleneck.

In some embodiments, the joint position estimation and camera parameter estimation block includes: an inverted residual block; and a convolution block.

In some embodiments, the joint position estimation and camera parameter estimation block further includes: an average pooling block; and a batch normalization block.

According to an embodiment of the present disclosure, there is provided a system including: one or more processors; and a memory storing instructions which, when executed by the one or more processors, cause performance of: generating a first two-dimensional joint position estimate relative to a first camera in a first camera position; generating a second two-dimensional joint position estimate relative to a second camera in a second camera position; generating an estimated three-dimensional joint position based at least on: a rotation transformation between the first camera position and the second camera position, a generated translational transformation between the first camera position and the second camera position, the first two-dimensional joint position estimate, and the second two-dimensional joint position estimate; and transmitting the generated three-dimensional joint position estimate.

In some embodiments, generating the three-dimensional joint position estimate includes generating a depth component of the three-dimensional joint position estimate, the depth component derived from a ratio of a first function of the translational transformation between the first camera position and the second camera position, and a second function of the rotational transformation between the first camera position and the second camera position.

In some embodiments, the first function of the translational transformation between the first camera position and the second camera position is further based on a difference between a first term and a second term, the first term being based on a first component of the second two-dimensional joint position estimate, and the second term being based on a second component of the second two-dimensional joint position estimate.

In some embodiments, the first term is further based on a set of intrinsic parameters of the second camera.

In some embodiments, the first term is further based on a first component of the translational transformation between the first camera position and the second camera position.

In some embodiments, the generating of the first two-dimensional joint position estimate relative to the first camera position includes utilizing a machine learning model, the model including: an object detection backbone; and a joint position estimation and camera parameter estimation block.

In some embodiments, the object detection backbone includes: a convolution block; a Tucker block; and a fused inverted bottleneck.

In some embodiments, the joint position estimation and camera parameter estimation block includes: an inverted residual block; and a convolution block.

In some embodiments, the joint position estimation and camera parameter estimation block further includes: an average pooling block; and a batch normalization block.

According to an embodiment of the present disclosure, there is provided a system including: means for processing; and a memory storing instructions which, when executed by the means for processing, cause performance of: generating a first two-dimensional joint position estimate relative to a first camera in a first camera position; generating a second two-dimensional joint position estimate relative to a second camera in a second camera position; generating an estimated three-dimensional joint position based at least on: a rotation transformation between the first camera position and the second camera position, a generated translational transformation between the first camera position and the second camera position, the first two-dimensional joint position estimate, and the second two-dimensional joint position estimate; and transmitting the generated three-dimensional joint position estimate.

In some embodiments, generating the three-dimensional joint position estimate includes generating a depth component of the three-dimensional joint position estimate, the depth component derived from a ratio of a first function of the translational transformation between the first camera position and the second camera position, and a second function of the rotational transformation between the first camera position and the second camera position.

### BRIEF DESCRIPTION OF THE DRAWINGS

In the following section, the aspects of the subject matter disclosed herein will be described with reference to exemplary embodiments illustrated in the figures, in which:

FIG. 1A is a system diagram showing a computing device and the hand of a user, according to an embodiment.

FIG. 1B is a diagram showing a stereoscopic imaging system of a computing device and the hand of a user, according to an embodiment.

FIG. 2 is a block diagram of a hand joint position estimation and camera parameter estimation model, according to an embodiment.

FIG. 3A is a block diagram of a fused inverted bottleneck, according to an embodiment.

FIG. 3B is a block diagram of a Tucker block, according to an embodiment.

FIG. 3C is a block diagram of an inverted residual block, according to an embodiment.

FIG. 4 is a flow chart, according to an embodiment.

FIG. 5 is a block diagram of an electronic device in a network environment, according to an embodiment.

FIG. 6 shows a system including a UE and a gNB in communication with each other, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

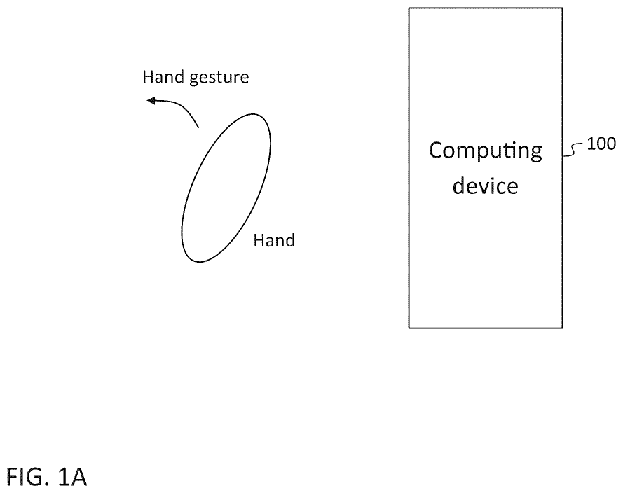

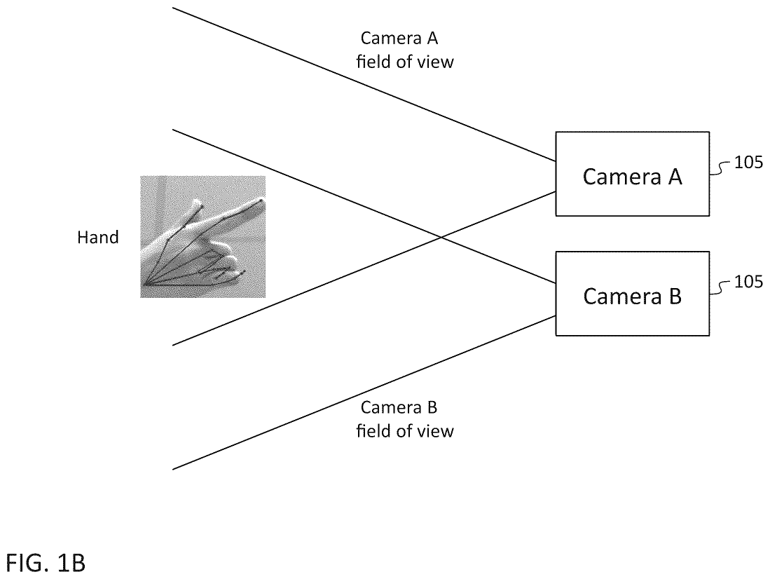

FIG. 1A shows a computing device 100 (e.g., a mobile computing device such as a laptop computer, a tablet computer, or a mobile telephone) interacting with the hand of a user. When a user interacts with such a computing device 100, it may be helpful for the user to provide instructions or to operate the mobile device using hand gestures. For example, the user may move her or his hand in a particular direction or by changing the shape of the hand, in order to communicate to the device certain desired operations on the part of the device. For example, the user may open her hand to indicate that an application is to be opened, or close her hand into a fist, to indicate that an application is to be closed. As another example, a user may point a finger to the left to indicate a desire to switch to a different application or to indicate a desire to move an application to the left, or to indicate a desire to move an object within an application, such as a character in a video game, to the left. Various other hand gestures may be used to communicate with a mobile computing device. For example, the device may be capable of understanding various standard sign language commands and the user may, in such a situation, dictate text to the mobile device using hand gestures.

As part of the process of receiving hand gesture input, the mobile device may form an internal representation of the hand of the user, that allows the mobile device to detect, from changes in the model, motion of the user's hand. The model of the user's hand may include for example an estimated position of each of the joints of the hand. It will be appreciated that the same techniques are applicable to any bodily joint, for example, each of the joints in a human leg or foot. For example, as depicted, each finger may be represented by the position of the fingertip, and of the three finger joints of the finger. As used herein, each fingertip, and the tip of the thumb, may each be considered to be a “joint” in and of itself. Each “joint” may be represented by its coordinates in three-dimensional space. The coordinate system with respect to which this representation is formed may be, for example, a coordinate system attached to the mobile device.

The mobile device may detect the positions of the user's hand joints, for example, using stereoscopic machine vision, as illustrated in FIG. 1B. For example, the mobile device may have two cameras 105 with overlapping fields of view, each of which captures a stream of images of the user's hand as the hand moves. The user device may then infer, from the images that it receives from the two cameras of the stereoscopic imaging system, the position of each joint of the hand. For example, processing methods implemented in the mobile device may detect in a first image, from the first camera, the position of each of the hand joints that are visible in the first image. The mobile device may then detect in a second image, from the second camera, the positions of all of the hand joints that are visible in the second image. The mobile device may then determine which hand joint in the first image corresponds to which hand joint in the second image and, from the geometry of the stereoscopic imaging system and the coordinates of the hand joint in each of the two images received, it may calculate the three-dimensional position of the hand joint with respect to the camera system, as discussed in further detail below.

Given the two-dimensional coordinates of a hand joint in a first camera (which may be referred to as camera A) and the two-dimensional coordinates of the hand joint in a second camera (which may be referred to as camera B), the three-dimensional coordinates of the hand joint may be calculated based on the following derivation.

The virtual camera parameters are in the form of a three tuple:

$$Camera = ( {t}_{x} , {t}_{y} , sc ) , \qquad ( 1 )$$

which is related to the camera extrinsic parameter

$$t = ( {t}_{x} , {t}_{y} , {t}_{z} ) , \qquad ( 2 )$$

Where tₓ, t_{y}, and t_{z} are components of the camera extrinsic parameter t and where t_{z} is defined as the scaled arbitrary value

$${t}_{z} = \frac{f}{\frac{S}{2} sc} = \frac{f}{\frac{224}{2} sc} , \qquad ( 3 )$$

where S=224 for the resolution of the input image, and the focal length f=1000 is chosen to be a relatively large value to mimic the weak perspective camera setting. The variable “sc” in Equation 3 is the same as the scale kₒ in the scaled orthographic projection discussed below.

Scaled orthographic projection may be trained during the training of a hand joint position estimation and camera parameter estimation model (discussed in further detail below), which may be used to generate two-dimensional position estimates of hand joints, and which may also be capable of, and used for, camera parameter estimation. Scaled orthographic projection is an orthographic projection followed by isotropic scaling. The orthographic projection matrix Po may be defined as

$${P}_{o} = [ \begin{matrix}1 & & \\ & 1 & \\ & & 1 / {k}_{0}\end{matrix} ] [ \begin{matrix}{r}^{1 T} & {t}_{x} \\ {r}^{2 T} & {t}_{y} \\ {0}^{T} & 1\end{matrix} ] = [ \begin{matrix}{r}^{1 T} & {t}_{x} \\ {r}^{2 T} & {t}_{y} \\ {0}^{T} & 1 / {k}_{o}\end{matrix} ] \qquad ( 4 )$$

where r^{iT} is the i^{th} row of the rotation matrix, and kₒ is the scaling factor. The image coordinate projection may be obtained as

$${λ}_{o} [ \begin{matrix}x \\ y \\ 1\end{matrix} ] = {P}_{o} X = [ \begin{matrix}{r}^{1 T} & {t}_{x} \\ {r}^{2 T} & {t}_{y} \\ {0}^{T} & 1 / {k}_{o}\end{matrix} ] [ \begin{matrix}X \\ Y \\ Z \\ 1\end{matrix} ] = \frac{1}{{k}_{o}} [ \begin{matrix}{k}_{o} ( X + {t}_{x} ) \\ {k}_{o} ( Y + {t}_{y} ) \\ 1\end{matrix} ] , \qquad ( 5 )$$

where X=[X, Y, Z, 1]^{T} is the three-dimensional (3D) point X coordinate, and R=I for no camera rotation. The resulting 2D projection has no true depth, but an arbitrary depth λₒ=1/kₒ. It may be observed that x, y∈[1, 1]. Accordingly, the pixel domain coordinate can be found as

$${λ}_{o} [ \begin{matrix}u \\ v \\ 1\end{matrix} ] = {λ}_{o} [ \begin{matrix}S / 2 & & S / 2 \\ & S / 2 & S / 2 \\ & & 1\end{matrix} ] [ \begin{matrix}x \\ y \\ 1\end{matrix} ] \qquad ( 6 )$$

$$= {λ}_{o} [ \begin{matrix}S / 2 & & S / 2 \\ & S / 2 & S / 2 \\ & & 1\end{matrix} ] [ \begin{matrix}{k}_{o} ( X + {t}_{x} ) \\ {k}_{o} ( Y + {t}_{y} ) \\ 1\end{matrix} ] = {λ}_{o} [ \begin{matrix}( {k}_{o} S / 2 ) ( X + {t}_{x} ) + S / 2 \\ ( {k}_{o} S / 2 ) ( Y + {t}_{y} ) + S / 2 \\ 1\end{matrix} ] , \qquad ( 7 )$$

where kₒ=sc in the predicted virtual camera parameters.

In visualization, a pinhole camera with perspective projection may be assumed. The projected pixel domain projection may be obtained as

$${λ}_{p} [ \begin{matrix}u \\ v \\ 1\end{matrix} ] = K [ R t ] X = [ \begin{matrix}f & & {c}_{x} \\ & f & {c}_{y} \\ & & 1\end{matrix} ] [ \begin{matrix}1 & & & {t}_{x} \\ & 1 & & {t}_{y} \\ & & 1 & {t}_{z}\end{matrix} ] X , \qquad ( 8 )$$

cₓ and c_{y} may be set to be equal to

$$\frac{S}{2} = 112$$

for simplicity.

The scaling factor λₚ may be obtained as

$${λ}_{p} = Z + {t}_{z} , \qquad ( 9 )$$

and the two-dimensional (2D) projections may be obtained as

$${λ}_{p} [ \begin{matrix}u \\ v \\ 1\end{matrix} ] = {λ}_{p} [ \begin{matrix}\frac{f ( X + {t}_{x} )}{Z + {t}_{z}} + {c}_{x} \\ \frac{f ( Y + {t}_{y} )}{Z + {t}_{z}} + {c}_{y} \\ 1\end{matrix} ] = {λ}_{p} [ \begin{matrix}\frac{f ( X + {t}_{x} )}{\frac{Z}{f} + \frac{{t}_{z}}{f}} + \frac{S}{2} \\ \frac{f ( Y + {t}_{y} )}{\frac{Z}{f} + \frac{{t}_{z}}{f}} + \frac{S}{2} \\ 1\end{matrix} ] \qquad ( 10 )$$

It may be observed that, in case of perfect orthogonal projection, Z/f=0 and in case of weak perspective projection Z/f≈0.

The scaled orthographic projection in Equation 6 and the perspective projection in Equation 10 may then be aligned. To achieve this, the “wrist” of the hand may be set to the origin of the world coordinate in such a way that Z=0 for the “wrist” (where the “wrist” is modeled as a simple joint and the corresponding center point of the joint). For other vertices or joints, Z≠0. Since the camera rotation R is assumed to be an identity matrix, the remaining task is to find the translation vector t. The components tₓ and t_{y} may be obtained from the learned camera parameters, and t_{z} can be obtained by comparing Equation 6 and Equation 10:

$$\frac{f}{{λ}_{p}} = \frac{S / 2}{{λ}_{o}} \to {t}_{z} = {λ}_{p} = \frac{f {λ}_{o}}{S / 2} = \frac{f}{\frac{S}{2} sc} . \qquad ( 11 )$$

As a result, the 2D projections for the “wrist” are

$${λ}_{p} [ v ] = {λ}_{p} [ + S / 2 ] = {λ}_{p} [ 1 + S / 2 ] \qquad ( 12 )$$

For the other vertices or joints,

$${λ}_{p} [ \begin{matrix}u \\ v \\ 1\end{matrix} ] = {λ}_{p} [ \begin{matrix}\frac{f ( X + {t}_{x} )}{Δ Z + \frac{f}{\frac{S}{2} sc}} + \frac{S}{2} \\ \frac{f ( Y + {t}_{y} )}{Δ Z + \frac{f}{\frac{S}{2} sc}} + \frac{S}{2} \\ 1\end{matrix} ] = {λ}_{p} [ \begin{matrix}\frac{X + {t}_{x}}{\frac{Δ Z}{f} + \frac{1}{\frac{S}{2} sc}} + \frac{S}{2} \\ \frac{Y + {t}_{y}}{\frac{Δ Z}{f} + \frac{1}{\frac{S}{2} sc}} + \frac{S}{2} \\ 1\end{matrix} ] \qquad ( 13 )$$

A consistent projection method may be used to generate 2D joints and 3D meshes.

The model may be trained, and inference performed, with input image resolution S=224. However, the square image patch obtained from palm detection may have varied resolution, which may be designated S′. The magnification factor can be obtained as k=S′/S. Assuming the 3D point P coordinate does not change, the projected 2D coordinate on the new resolution S′ can be obtained as:

$${λ}^{′} [ \begin{matrix}{u}^{′} \\ {v}^{′} \\ 1\end{matrix} ] = {K}^{′} [ \begin{matrix}R & t\end{matrix} ] P = K [ \begin{matrix}k & & \\ & k & \\ & & 1\end{matrix} ] [ \begin{matrix}R & t\end{matrix} ] P \qquad ( 14 )$$

where it may be shown that λ′=λ=Z+t_{z} and

$${K}^{′} = [ \begin{matrix}k f & & {c}_{x} \\ & k f & {c}_{y} \\ & & 1\end{matrix} ] . \qquad ( 15 )$$

A perspective model for the cameras may then be formed as follows.

Perspective projection may be performed as follows. For a given perspective camera intrinsic parameter, to obtain the absolute 3D positions of the hand joints or the mesh vertices in the camera space, either a reference bone length or the 3D coordinate of the “wrist” may be used. In a mathematical formula, the 2D projection uᵢ=[uᵢ, vᵢ]^{T} of 3D points or 3D vertices

$${P}_{i}^{r} = {[ {X}_{i}^{r} , {Y}^{r} , {Z}_{i}^{r} ]}^{T} ,$$

with i∈{0, . . . , 777} for a hand mesh or i∈{0, 20} for hand joints, may be obtained as

$${λ}_{i} [ \begin{matrix}{u}_{i} \\ 1\end{matrix} ] = K [ \begin{matrix}R & t\end{matrix} ] [ \begin{matrix}{sP}_{i}^{r} \\ 1\end{matrix} ] = K [ \begin{matrix}R & t\end{matrix} ] [ \begin{matrix}{sX}_{i}^{r} \\ {sY}_{i}^{r} \\ s {Z}_{i}^{r} \\ 1\end{matrix} ] , \qquad ( 16 )$$

where s is the scaling obtained from bone length, t is the camera translation, and K is the camera intrinsic parameter. The same relationship is also true for the hand joints. In the camera space, R may be set to be equal to an identity matrix without loss of generality. Therefore,

$${λ}_{i} \overline{u} = {λ}_{i} [ \begin{matrix}{u}_{i} \\ 1\end{matrix} ] = K ( s {P}_{i}^{r} + t ) = K {P}_{i} . \qquad ( 17 )$$

In such a formulation, the camera is located at −t in the world frame, the “wrist” location is at t in camera space, and the absolute 3D hand location may be obtained as

$${X}_{i} . {λ}_{i} = {Z}_{i}^{r} + {t}_{z}$$

The scaling factor s may be obtained from the length l_{ref} of the reference bone, which is the phalangeal proximal bone of the middle fnger (i.e. between keypoints 9 and 10) and its length is provided in meters, i.e.

$$s = \frac{{l}_{r e f}}{‖ {P}_{9}^{r} - {P}_{10}^{r} ‖} . \qquad ( 18 )$$

By the given camera intrinsic parameter matrix K, the hand joint position estimation and camera parameter estimation model need only learn the translation t of the hand in the camera space.

Perspective transformation may be performed in image cropping as follows.

In hand pose estimation with HO3D data, the input image may be cropped and resized to keep the image size consistent with the FreiHAND data. The method may use a known upper left corner of the hand in an image uᵤₗ=[uᵤₗ, vᵤₗ], where uᵤₗ and vᵤₗ are the horizontal and vertical pixel coordinates of the upper left corner, respectively. Similarly, the bottom right corner of the patch may be defined as

$${u}_{b r} = [ {u}_{br} , {v}_{b r} ] .$$

The square patch may be cropped from uᵤₗ to u_{br}, and the extracted patch size is m×m. Prior to feeding the patches to the hand joint position estimation and camera parameter estimation model, the patch may be resized to 224×224 to align with all other datasets. Therefore, the scale ratio is

$$r = \frac{224}{m}$$

and the coordinate of the 2D hand joints uᵢ=[uᵢ, vᵢ], where i∈{0, 777} for hand mesh or i∈{0, 20} for hand joints, may be obtained in the scaled patch as:

$${u}_{i} = r ( {u}_{i}^{o} - {u}_{ul} ) , \qquad ( 19 )$$

where

$${u}_{i}^{o}$$

the original 2D coordinate of the hand joints. Without changing the 3D coordinate of hand joints/vertices, the camera intrinsic parameter matrix may be updated to meet the condition that the 3D hand joints or vertices are projected to the transformed 2D coordinates uᵢ:

$${K}^{′} {P}_{i} = {λ}_{i} [ \begin{matrix}{u}_{i} \\ 1\end{matrix} ] = {λ}_{i} \overline{u} , \qquad ( 20 )$$

where K′ is the updated camera intrinsic parameter matrix. Combining Equation 19 and Equation 20, the updated camera intrinsic parameter matrix may be obtained:

$${K}^{′} = [ \begin{matrix}rf & & r ( {c}_{x} - {u}_{ul} ) \\ & rf & r ( {c}_{x} - {u}_{ul} ) \\ & & 1\end{matrix} ] . \qquad ( 21 )$$

Perspective transformation in data augmentation may be performed as follows.

To improve the robustness of the hand joint position estimation and camera parameter estimation model, rotation, scale and shift augmentation may be applied while training the model. Such an approach may differ from the augmentation in orthographic projection in which 3D hand joints or vertices may be transformed with the 2D rotation/scale/shift matrix and depth information can be ignored. The mesh vertices or joint depth information may be considered in the transformation process in the perspective camera case.

In the rotation augmentation, the n×n RGB image or 2D points are rotated with a random angle θ with respect to a certain center

$$\overline{{c}_{r}} = {[ {c}_{u}^{r} , {c}_{v}^{r} , 1 ]}^{T}$$

After rotation, the resulting image may be shifted with respect to another center

$$\overline{{c}_{s}} = {[ {c}_{u}^{s} , {c}_{v}^{s} , 1 ]}^{T} .$$

Therefore, a transformed 2D joint may be calculated as:

$${\overline{u}}_{i} = R ( \overline{{u}_{i}} - \overline{{c}_{r}} ) + \overline{{c}_{s}} , \qquad ( 22 )$$

where

$${\overline{u}}_{i}^{′} = {[ {u}_{i} , 1 ]}^{T}$$

is an original 2D hand joint position as in Equation 17,

$${\overline{u}}_{i}^{′} = {[ {u}_{i}^{′} , 1 ]}^{T}$$

is the transformed 2D hand joint, and R is the 2D rotation matrix,

$$R = [ \begin{matrix}cos θ & - sin θ & \\ sin θ & cos θ & \\ & & 1\end{matrix} ] , \qquad ( 23 )$$

where θ is the rotation angle. Therefore, the transformed 3D hand joint

$${P}_{i}^{′}$$

may meet the condition that

$${λ}_{i}^{′} \overline{u} = {KP}_{i}^{′} . \qquad ( 24 )$$

Since the 2D rotation does not change the depth of the 3D joints,

$${λ}_{i}^{′} = {λ}_{i} = {Z}_{i}^{r} + {t}_{z} .$$

Thus, combining with Eq. (22) and Eq. (17), the transformed 3D joint may be obtained as

$${P}_{i}^{′} = {K}^{- 1} ( R ( K {P}_{i} - {λ}_{i} {\overline{c}}_{r} ) + {λ}_{i} \overline{{c}_{s}} ) . \qquad ( 25 )$$

In scaling augmentation, the input 2D red green blue (RGB) image or 2D hand joints may be resized with a random scaling factor α:

$$\overline{u} = α ( \overline{{u}_{i}} - \overline{{c}_{α}} ) + {\overline{c}}_{s} \qquad ( 26 )$$

where the image is scaled with respect to a certain center

$$\overline{c} = {[ {c}_{u}^{α} , {c}_{v}^{α} , 1 ]}^{T} .$$

Similarly, the transformed 3D hand joint may meet the condition of Equation 24. There are two possible choices:
(i) Without changing the scale of the hand, the depth of the hand may be set as

$${λ}_{i}^{′} = \frac{{λ}_{i}}{α} . \qquad ( 27 )$$

Combining Equation 27, Equation 26, Equation 24 and Equation 17, it is possible to obtain:

$${P}_{i}^{′} = {P}_{i} + {λ}_{i} {K}^{- 1} ( \frac{1}{α} \overline{{c}_{s}} - \overline{{c}_{α}} ) \qquad ( 28 )$$

(ii) The camera intrinsic parameter K may be updated to K′ (while keeping the 3D hand joints or vertices Pᵢ) in order to improve the robustness of the model to different camera intrinsic parameters:

$${λ}_{i} {\overline{u}}_{i}^{′} = {K}^{′} {P}_{i} . \qquad ( 29 )$$

Combining Equation 27, Equation 26, Equation 29 and Equation 17 it is possible to obtain:

$${K}^{′} = [ \begin{matrix}α f & & α ( {c}_{x} - {c}_{u}^{α} ) + {c}_{u}^{s} \\ & α f & α ( {c}_{y} - {c}_{v}^{α} ) + {c}_{v}^{s} \\ & & 1\end{matrix} ] . \qquad ( 30 )$$

Depth estimation from stereo cameras may then be performed as follows, to estimate the 3D hand joints from images of stereo cameras with the hand joint position estimation and camera parameter estimation model trained with single camera images. The depth may be estimated with the extrinsic parameter from camera A to camera B. K^{A} and K^{B} may be set as the intrinsic parameters of camera A and camera B respectively. R^{AB} and t^{AB}may be set as the rotation and translation parameter from camera A to camera B, which may also be referred to as (i) the “rotation transformation” between camera A and camera B, and (ii) the translational difference (or “translational transformation”) between camera A and camera B, respectively. Considering estimated 2D hand joints u̅^̅{̅A̅}̅, u̅^̅{̅B̅}̅ (whose i^{th} element (with i identifying the hand joint) is

$${\overline{u}}_{i}^{A} = {[ {u}_{i}^{A} , {v}_{i}^{A} , 1 ]}^{T} , {\overline{u}}_{i}^{B} = {[ {u}_{i}^{B} , {v}_{i}^{B} , 1 ]}^{T} )$$

and 3D hand joints P^{A}, P^{B} (whose iₜₕ element is

$${P}_{i}^{A} = {[ {x}_{i}^{A} , {y}_{i}^{A} , {z}_{i}^{A} ]}^{T} , {P}_{i}^{B} = {[ {u}_{i}^{B} , {v}_{i}^{B} , {z}_{i}^{B} ]}^{T} )$$

from the two cameras:

$${K}^{A} {P}_{i}^{A} = {\overline{u}}_{i}^{A} {z}_{i}^{A} , {K}^{B} {P}_{i}^{B} = {\overline{u}}_{i}^{B} {z}_{i}^{B} . \qquad ( 31 )$$

The quantities

$${\overline{u}}_{i}^{A} and {\overline{u}}_{i}^{B}$$

may be referred to as (i) a two-dimensional position estimate of a hand joint (the i^{th} joint) with respect to camera A, and (ii) a two-dimensional position estimate of a hand joint (the i^{th} joint) with respect to camera B, respectively. With rotation and translation parameters between the two cameras, the 3D hand joints may be transformed from camera A to camera B:

$${R}^{A B} {P}_{i}^{A} + {t}^{A B} = {P}_{i}^{B} . \qquad ( 32 )$$

Combining Equation 31 and 32:

$${{R}^{A B} ( {K}^{A} )}^{- 1} {\overline{u}}_{i}^{A} {z}_{i}^{A} + {t}^{A B} = {( {K}^{B} )}^{- 1} {\overline{u}}_{i}^{B} {z}_{i}^{B} . \qquad ( 33 )$$

By setting

$$a = {{R}^{A B} ( {K}^{A} )}^{- 1} {\overline{u}}_{i}^{A} and b = {( {K}^{B} )}^{- 1} {\overline{u}}_{i}^{B} ,$$

the value of

$${z}_{i}^{A}$$

may be found:

$${z}_{i}^{A} = - \frac{{t}_{1}^{A B} {b}_{3} - {t}_{3}^{A B} {b}_{1}}{{a}_{1} {b}_{3} - {a}_{3} {b}_{1}} . \qquad ( 34 )$$

Equation 34 may be used to calculate a depth component

$$( {z}_{i}^{A} )$$

of the three-dimensional position of a hand joint (the i^{th} joint) as a numerator

$$( {t}_{1}^{A B} {b}_{3} - {t}_{3}^{A B} {b}_{1} or - {t}_{1}^{A B} {b}_{3} - {t}_{3}^{A B} {b}_{1} )$$

divided by a denominator (a₁b₃−a₃b₁), the numerator being based on (e.g., being a first function of (or a first function based on)) the translational difference between camera A and camera B, and the denominator being based on (e.g., being a second function of (or a second function based on)) the rotation transformation between camera A and camera B. With estimated depth of 3D hand joints from camera A and B

$$( {z}_{i}^{A} and {z}_{i}^{B}$$

respectively) with Equation 33 and 34, the 3D hand joints may be obtained using Equation 31. The 3D hand joint position estimates may then be transmitted, e.g., to an application running on the mobile device, which may further analyze the sets of estimated hand joint coordinates for hand signals, gestures, or the like.

In conditions when the two cameras are rectified, the following conditions may hold:

$${K}^{B} = {K}^{A} = [ \begin{matrix}f & & \\ & f & \\ & & 1\end{matrix} ] \qquad ( 35 )$$

$${t}^{A B} = {[ {t}_{1}^{A B} , 0 , 0 ]}^{T} \qquad ( 36 )$$

Then the following modified version of Equation 34 may be obtained:

$${z}_{i}^{A} = \frac{{t}_{1}^{A B} f}{{u}_{i}^{A} - {u}_{i}^{B}} = {z}_{i}^{B} . \qquad ( 36 )$$

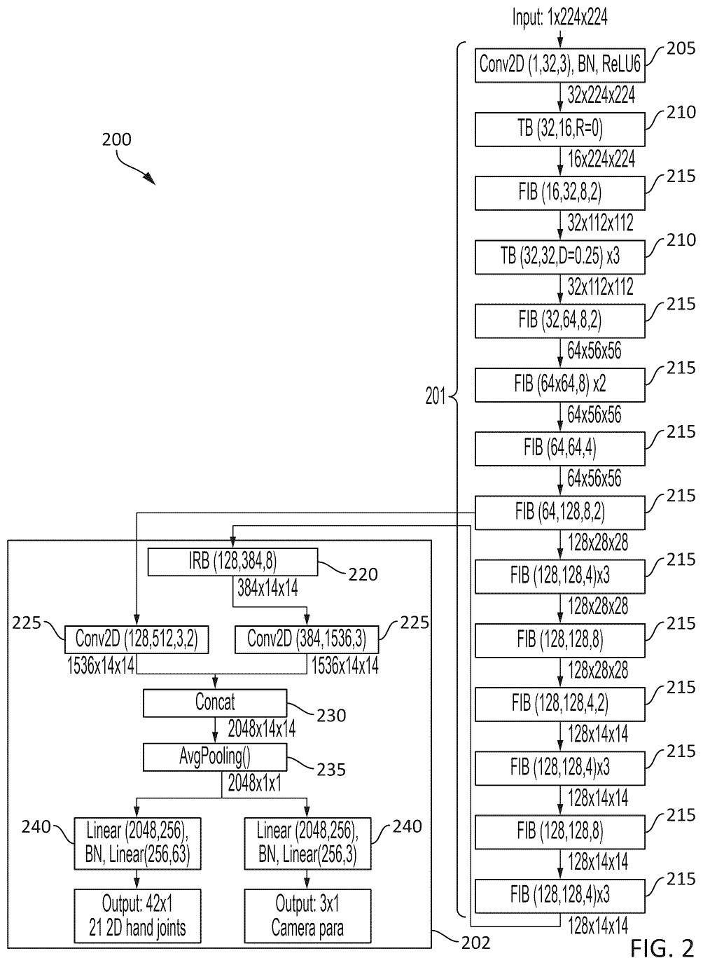

In some embodiments, as mentioned above, the two-dimensional estimates of hand joint position may be produced by the hand joint position estimation and camera parameter estimation model 200, which may be a machine learning model, for example, a neural network, as illustrated in FIG. 2. Such a neural network may also, as mentioned above, generate estimates of the camera parameters. In some embodiments the camera parameters may be measured at the time of manufacture of the mobile device, or determined at the time of design of the mobile device, instead of, or in addition to, being estimated by the machine learning model.

The hand joint position estimation and camera parameter estimation model may include a backbone 201 and a hand joint position estimation and camera parameter estimation block 202. The backbone 201 may include an input block 205, two Tucker blocks (TBs) 210, and a plurality of fused inverted bottlenecks (FIBs) 215. The input block 205 may include a convolution block (e.g., a two-dimensional convolution block (Conv2D)), a batch normalization (BN) block and a rectified linear unit (ReLU).

The hand joint position estimation and camera parameter estimation block 202 may include an inverted residual block (IRB) 220 connected to the output of the backbone 201, and two two-dimensional convolution blocks 225, one of which is connected to the output of the inverted residual block 220 and the other of which is connected to the output of one of the fused inverted bottlenecks (FIBs) 215 of the backbone 201, as shown. In some embodiments, one or more of the two-dimensional convolution blocks 225 may be replaced with a different neural network, e.g., with a respective transformer block. The hand joint position estimation and camera parameter estimation block 202 may further include (i) a concatenation block 230 connected to the outputs of the two two-dimensional convolution blocks 225 and configured to concatenate the outputs of the two two-dimensional convolution blocks 225, (ii) an average pooling block 235 connected to the output of the concatenation block 230, and (iii) two output blocks 240, each connected to the output of the average pooling block 235. In some embodiments, the average pooling block 235 may be replaced with, e.g., a linear block (e.g., a one dimensional (1D) convolutional layer) or a two-dimensional convolution block. Each of the two output blocks 240 may include two linear blocks, and a batch normalization block; the two output blocks 240 may be configured to calculate (i) two-dimensional position estimates of hand joints (e.g., to generate 42-dimensional output vectors each include 21 two-dimensional hand joint estimates, the 21 hand joints including one hand joint for the wrist, four joints for each finger and four joints of the thumb) and (ii) camera parameters, e.g., tₓ, t_{y}, and sc. In some embodiments, one or more of the linear blocks (which may be employed to transform the dimensions of an input feature map) may be replaced with one or more respective transformer blocks, and one or more of the batch normalization blocks may be replaced with a respective layer norm block. The hand joint position estimation and camera parameter estimation model 200 may be trained using supervised training, with a training dataset including (e.g., consisting of) labeled pairs of images of hands, each pair of images forming a stereoscopic image.

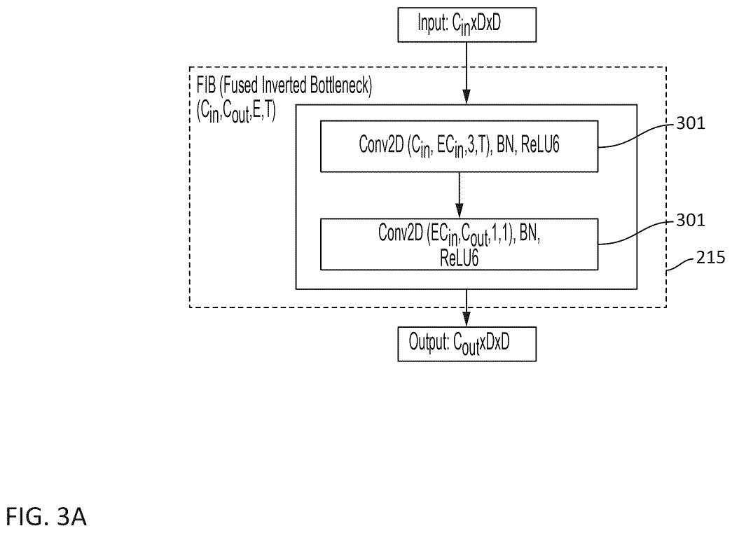

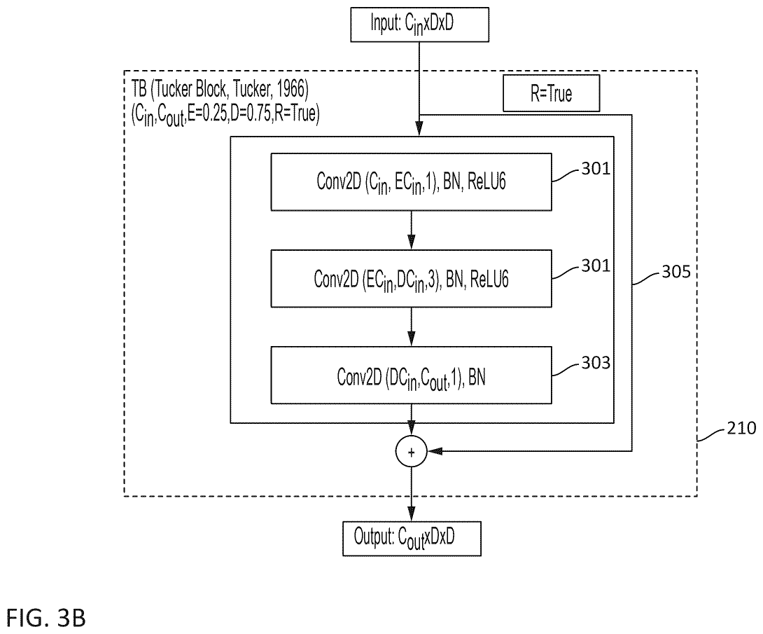

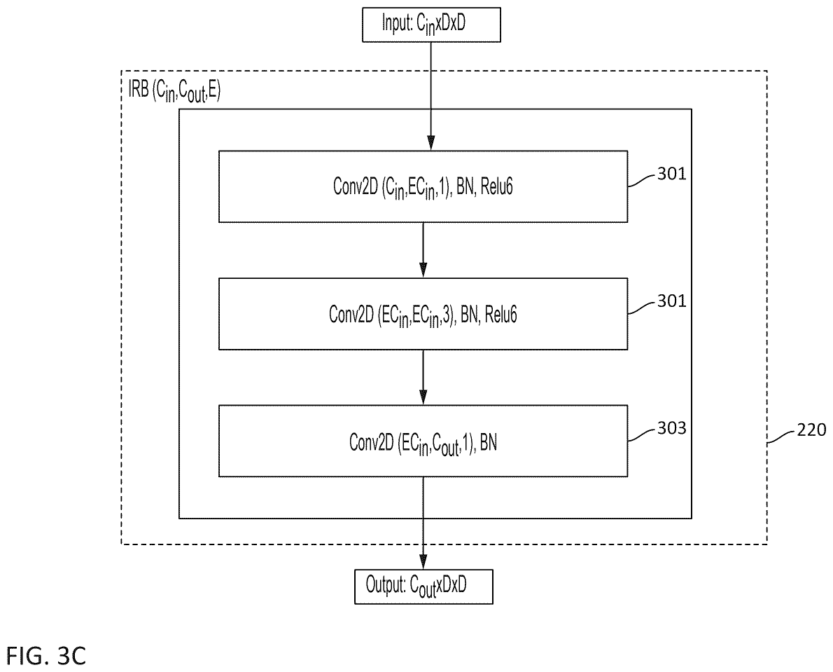

FIG. 3A shows the internal structure of a fused inverted bottleneck (FIB) 215, in some embodiments. The fused inverted bottleneck 215 includes two processing blocks 301, connected in cascade, i.e., with the output of a first one of the two processing blocks 301 connected to the input of the second one of the two processing blocks 301. Each of the two processing blocks 301 includes a two-dimensional convolution block, a batch normalization block, and a rectified linear unit with maximum size of 6 (ReLU6).

FIG. 3B shows the internal structure of a Tucker block 210, in some embodiments. The Tucker block 210 includes two processing blocks 301 and an output block 303. The two processing blocks 301 are connected in cascade, i.e., with the output of a first one of the two processing blocks 301 connected to the input of a second one of the two processing blocks 301, and with the output of the second one of the two processing blocks 301 connected to the input of the output block 303. In addition, a bypass connection 305 sums the input of the Tucker block 210 with the output of the output block 303, at the output of the Tucker block 210.

FIG. 3C shows the internal structure of an inverted residual block 220, in some embodiments. The inverted residual block 220 includes two processing blocks 301, each including a two-dimensional convolution block, a batch normalization block, and a rectified linear unit with maximum size of 6 (ReLU6). The inverted residual block 220 further includes an output block 303 including a two-dimensional convolution block and a batch normalization block. The two processing blocks 301 are connected in cascade at the input of the inverted residual block 220, and the output block 303 is connected between the cascade of the two processing blocks 301 and the output of the inverted residual block 220.

The use of a relatively small hand joint position estimation and camera parameter estimation model 200 such as that illustrated in FIG. 2, or the use of the relatively simple calculation of the depth of a hand joint using, e.g., Equation 34, may make it possible for a computing system of a mobile device (which may have limited memory, computing resources, and power resources) to perform hand pose estimation; this may not be feasible absent the use of embodiments disclosed herein. As such, the systems and methods disclosed herein may include an improvement to the functioning of a computer in the mobile device, and an improvement to the technology of estimating hand pose.

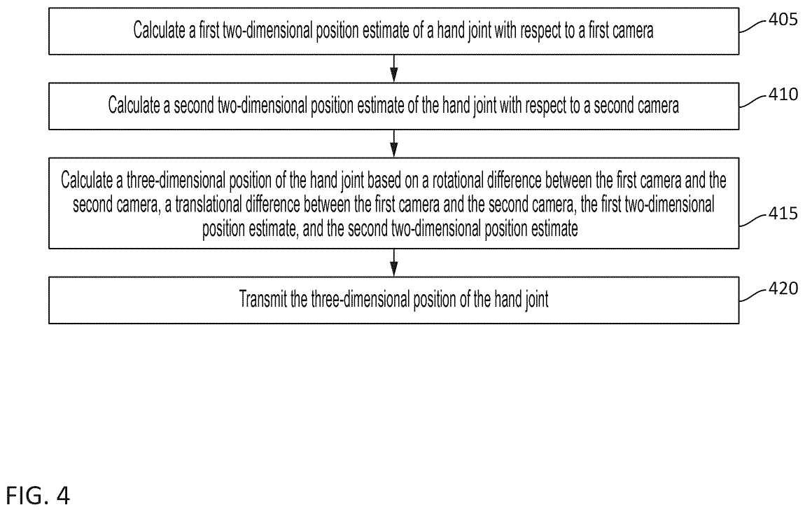

FIG. 4 shows a method, in some embodiments. Although FIG. 4 illustrates various operations in a method of hand pose estimation, embodiments according to the present disclosure are not limited thereto. For example, according to some embodiments, a method of hand pose estimation may include additional operations or fewer operations, or the order of operations may vary (unless otherwise explicitly stated or implied) without departing from the spirit and scope of embodiments according to the present disclosure.

The method includes calculating, at 405, a first two-dimensional position estimate of a hand joint with respect to a first camera. This may be performed, as discussed above in the context of FIG. 2, by a hand joint position estimation and camera parameter estimation model 200, based on stereoscopic images obtained by two cameras of a mobile device. The method further includes calculating, at 410, a second two-dimensional position estimate of the hand joint with respect to a second camera; this may also be performed by the hand joint position estimation and camera parameter estimation model 200. The method further includes calculating, at 415, a three-dimensional position of the hand joint based on: a rotational difference between the first camera and the second camera, a translational difference between the first camera and the second camera, the first two-dimensional position estimate, and the second two-dimensional position estimate. This may be performed using Equation 34, for example. The method further includes transmitting the three-dimensional position of the hand joint. This transmitting may include, for example, transmitting the three-dimensional position of the hand joint to an application running on the mobile device, as mentioned above.

In some embodiments, the calculating of the three-dimensional position of the hand joint includes calculating a depth component of the three-dimensional position as a numerator divided by a denominator, the numerator being based on the translational difference between the first camera and the second camera, and the denominator being based on the rotational difference between the first camera and the second camera. In some embodiments, the numerator includes a difference between a first term and a second term, the first term being based on a first component of the second two-dimensional position estimate, and the second term being based on a second component of the second two-dimensional position estimate. In some embodiments, the first term is further based on a set of intrinsic parameters of the second camera. In some embodiments, the first term is further based on a first component of the translational difference between the first camera and the second camera. In some embodiments, the calculating of the first two-dimensional position estimate of the hand joint with respect to the first camera includes using a machine learning model including: an object detection backbone; and a hand joint position estimation and camera parameter estimation block. In some embodiments, the object detection backbone includes: a convolution block; a Tucker block; and a fused inverted bottleneck. In some embodiments, the hand joint position estimation and camera parameter estimation model includes: an inverted residual block; and a convolution block. In some embodiments, the hand joint position estimation and camera parameter estimation model further includes: an average pooling block; and a batch normalization block.

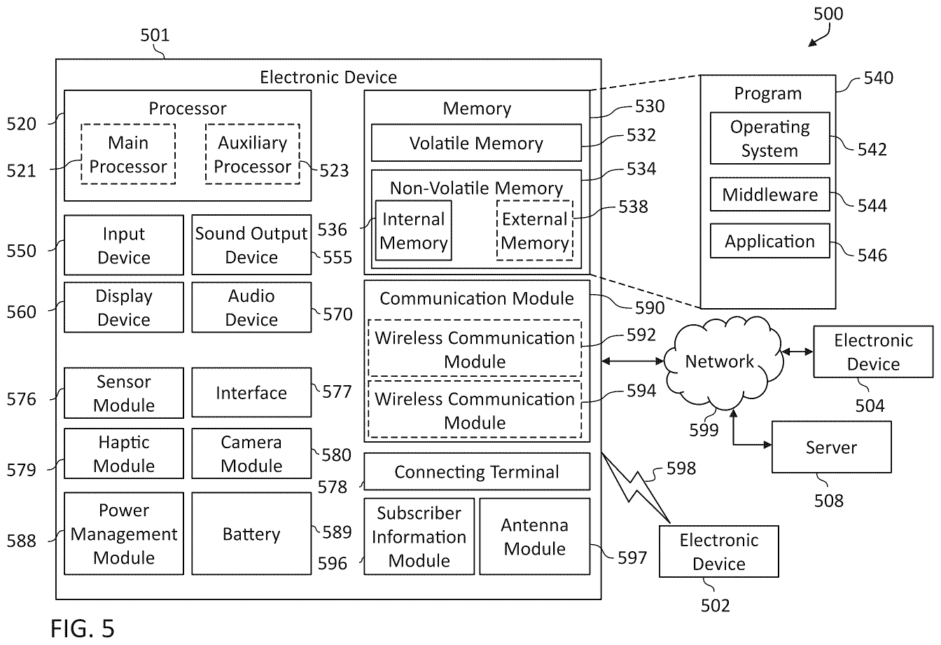

FIG. 5 is a block diagram of an electronic device 501 in a network environment 500, according to an embodiment. The electronic device 501 may be configured to interact with a user (e.g., the electronic device 501 may include a display and a stereoscopic imaging system including two cameras 105) and the electronic device 501 may be configured to perform hand pose estimation according to embodiments disclosed herein.

Referring to FIG. 5, an electronic device 501 in a network environment 500 may communicate with an electronic device 502 via a first network 598 (e.g., a short-range wireless communication network), or an electronic device 504 or a server 508 via a second network 599 (e.g., a long-range wireless communication network). The electronic device 501 may communicate with the electronic device 504 via the server 508. The electronic device 501 may include a processor 520, a memory 530, an input device 550, a sound output device 555, a display device 560, an audio module 570, a sensor module 576, an interface 577, a haptic module 579, a camera module 580, a power management module 588, a battery 589, a communication module 590, a subscriber identification module (SIM) card 596, or an antenna module 597. In one embodiment, at least one (e.g., the display device 560 or the camera module 580) of the components may be omitted from the electronic device 501, or one or more other components may be added to the electronic device 501. Some of the components may be implemented as a single integrated circuit (IC). For example, the sensor module 576 (e.g., a fingerprint sensor, an iris sensor, or an illuminance sensor) may be embedded in the display device 560 (e.g., a display).

The processor 520 may execute software (e.g., a program 540) to control at least one other component (e.g., a hardware or a software component) of the electronic device 501 coupled with the processor 520 and may perform various data processing or computations.

As at least part of the data processing or computations, the processor 520 may load a command or data received from another component (e.g., the sensor module 576 or the communication module 590) in volatile memory 532, process the command or the data stored in the volatile memory 532, and store resulting data in non-volatile memory 534. The processor 520 may include a main processor 521 (e.g., a central processing unit (CPU) or an application processor (AP)), and an auxiliary processor 523 (e.g., a graphics processing unit (GPU), an image signal processor (ISP), a sensor hub processor, or a communication processor (CP)) that is operable independently from, or in conjunction with, the main processor 521. Additionally or alternatively, the auxiliary processor 523 may be adapted to consume less power than the main processor 521, or execute a particular function. The auxiliary processor 523 may be implemented as being separate from, or a part of, the main processor 521.

The auxiliary processor 523 may control at least some of the functions or states related to at least one component (e.g., the display device 560, the sensor module 576, or the communication module 590) among the components of the electronic device 501, instead of the main processor 521 while the main processor 521 is in an inactive (e.g., sleep) state, or together with the main processor 521 while the main processor 521 is in an active state (e.g., executing an application). The auxiliary processor 523 (e.g., an image signal processor or a communication processor) may be implemented as part of another component (e.g., the camera module 580 or the communication module 590) functionally related to the auxiliary processor 523.

The memory 530 may store various data used by at least one component (e.g., the processor 520 or the sensor module 576) of the electronic device 501. The various data may include, for example, software (e.g., the program 540) and input data or output data for a command related thereto. The memory 530 may include the volatile memory 532 or the non-volatile memory 534. Non-volatile memory 534 may include internal memory 536 and/or external memory 538.

The program 540 may be stored in the memory 530 as software, and may include, for example, an operating system (OS) 542, middleware 544, or an application 546.

The input device 550 may receive a command or data to be used by another component (e.g., the processor 520) of the electronic device 501, from the outside (e.g., a user) of the electronic device 501. The input device 550 may include, for example, a microphone, a mouse, or a keyboard.

The sound output device 555 may output sound signals to the outside of the electronic device 501. The sound output device 555 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 560 may visually provide information to the outside (e.g., a user) of the electronic device 501. The display device 560 may include, for example, a display, a hologram device, or a projector and control circuitry to control a corresponding one of the display, hologram device, and projector. The display device 560 may include touch circuitry adapted to detect a touch, or sensor circuitry (e.g., a pressure sensor) adapted to measure the intensity of force incurred by the touch.

The audio module 570 may convert a sound into an electrical signal and vice versa. The audio module 570 may obtain the sound via the input device 550 or output the sound via the sound output device 555 or a headphone of an external electronic device 502 directly (e.g., wired) or wirelessly coupled with the electronic device 501.

The sensor module 576 may detect an operational state (e.g., power or temperature) of the electronic device 501 or an environmental state (e.g., a state of a user) external to the electronic device 501, and then generate an electrical signal or data value corresponding to the detected state. The sensor module 576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 577 may support one or more specified protocols to be used for the electronic device 501 to be coupled with the external electronic device 502 directly (e.g., wired) or wirelessly. The interface 577 may include, for example, a high-definition multimedia interface (HDMI), a universal serial bus (USB) interface, a secure digital (SD) card interface, or an audio interface.

A connecting terminal 578 may include a connector via which the electronic device 501 may be physically connected with the external electronic device 502. The connecting terminal 578 may include, for example, an HDMI connector, a USB connector, an SD card connector, or an audio connector (e.g., a headphone connector).

The haptic module 579 may convert an electrical signal into a mechanical stimulus (e.g., a vibration or a movement) or an electrical stimulus which may be recognized by a user via tactile sensation or kinesthetic sensation. The haptic module 579 may include, for example, a motor, a piezoelectric element, or an electrical stimulator.

The camera module 580 may capture a still image or moving images. The camera module 580 may include one or more lenses, image sensors, image signal processors, or flashes. The power management module 588 may manage power supplied to the electronic device 501. The power management module 588 may be implemented as at least part of, for example, a power management integrated circuit (PMIC).

The battery 589 may supply power to at least one component of the electronic device 501. The battery 589 may include, for example, a primary cell which is not rechargeable, a secondary cell which is rechargeable, or a fuel cell.

The communication module 590 may support establishing a direct (e.g., wired) communication channel or a wireless communication channel between the electronic device 501 and the external electronic device (e.g., the electronic device 502, the electronic device 504, or the server 508) and performing communication via the established communication channel. The communication module 590 may include one or more communication processors that are operable independently from the processor 520 (e.g., the AP) and supports a direct (e.g., wired) communication or a wireless communication. The communication module 590 may include a wireless communication module 592 (e.g., a cellular communication module, a short-range wireless communication module, or a global navigation satellite system (GNSS) communication module) or a wired communication module 594 (e.g., a local area network (LAN) communication module or a power line communication (PLC) module). A corresponding one of these communication modules may communicate with the external electronic device via the first network 598 (e.g., a short-range communication network, such as BLUETOOTH™, wireless-fidelity (Wi-Fi) direct, or a standard of the Infrared Data Association (IrDA)) or the second network 599 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 592 may identify and authenticate the electronic device 501 in a communication network, such as the first network 598 or the second network 599, using subscriber information (e.g., international mobile subscriber identity (IMSI)) stored in the subscriber identification module 596.

The antenna module 597 may transmit or receive a signal or power to or from the outside (e.g., the external electronic device) of the electronic device 501. The antenna module 597 may include one or more antennas, and, therefrom, at least one antenna appropriate for a communication scheme used in the communication network, such as the first network 598 or the second network 599, may be selected, for example, by the communication module 590 (e.g., the wireless communication module 592). The signal or the power may then be transmitted or received between the communication module 590 and the external electronic device via the selected at least one antenna.

Commands or data may be transmitted or received between the electronic device 501 and the external electronic device 504 via the server 508 coupled with the second network 599. Each of the electronic devices 502 and 504 may be a device of a same type as, or a different type, from the electronic device 501. All or some of operations to be executed at the electronic device 501 may be executed at one or more of the external electronic devices 502, 504, or 508. For example, if the electronic device 501 should perform a function or a service automatically, or in response to a request from a user or another device, the electronic device 501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 501. The electronic device 501 may provide the outcome, with or without further processing of the outcome, as at least part of a reply to the request. To that end, a cloud computing, distributed computing, or client-server computing technology may be used, for example.

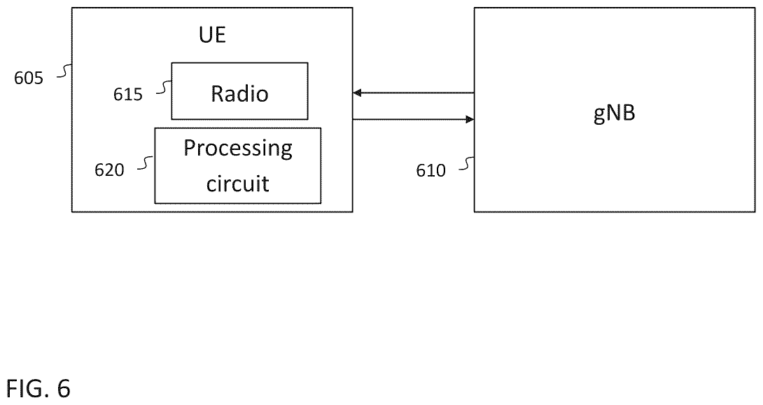

FIG. 6 shows a system including a UE 605 and a gNB 610, in communication with each other. The UE may include a radio 615 and a processing circuit (or a means for processing) 620, which may perform various methods disclosed herein, e.g., the method illustrated in FIG. 4. For example, the processing circuit 620 may receive, via the radio 615, transmissions from the network node (gNB) 610, and the processing circuit \hat{ }\hat{ }20 may transmit, via the radio 615, signals to the gNB 610.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method, comprising:
generating a first two-dimensional joint position estimate relative to a first camera in a first camera position;
generating a second two-dimensional joint position estimate relative to a second camera in a second camera position;
generating an estimated three-dimensional joint position based at least on:
a rotation transformation between the first camera position and the second camera position,
a generated translational transformation between the first camera position and the second camera position,
the first two-dimensional joint position estimate, and
the second two-dimensional joint position estimate; and
transmitting the generated three-dimensional joint position estimate.

2. The method of claim 1, wherein generating the three-dimensional joint position estimate comprises generating a depth component of the three-dimensional joint position estimate, the depth component derived from a ratio of a first function of the translational transformation between the first camera position and the second camera position, and a second function of the rotational transformation between the first camera position and the second camera position.

3. The method of claim 2, wherein the first function of the translational transformation between the first camera position and the second camera position is further based on a difference between a first term and a second term, the first term being based on a first component of the second two-dimensional joint position estimate, and the second term being based on a second component of the second two-dimensional joint position estimate.

4. The method of claim 3, wherein the first term is further based on a set of intrinsic parameters of the second camera.

5. The method of claim 4, wherein the first term is further based on a first component of the translational transformation between the first camera position and the second camera position.

6. The method of claim 1, wherein the generating of the first two-dimensional joint position estimate relative to the first camera position comprises utilizing a machine learning model, the model comprising:
an object detection backbone; and
a joint position estimation and camera parameter estimation block.

7. The method of claim 6, wherein the object detection backbone comprises:
a convolution block;
a Tucker block; and
a fused inverted bottleneck.

8. The method of claim 6, wherein the joint position estimation and camera parameter estimation block comprises:
an inverted residual block; and
a convolution block.

9. The method of claim 8, wherein the joint position estimation and camera parameter estimation block further comprises:
an average pooling block; and
a batch normalization block.

10. A system, comprising:
one or more processors; and
a memory storing instructions which, when executed by the one or more processors, cause performance of:
generating a first two-dimensional joint position estimate relative to a first camera in a first camera position;
generating a second two-dimensional joint position estimate relative to a second camera in a second camera position;
generating an estimated three-dimensional joint position based at least on:
a rotation transformation between the first camera position and the second camera position,
a generated translational transformation between the first camera position and the second camera position,
the first two-dimensional joint position estimate, and
the second two-dimensional joint position estimate; and
transmitting the generated three-dimensional joint position estimate.

11. The system of claim 10, wherein generating the three-dimensional joint position estimate comprises generating a depth component of the three-dimensional joint position estimate, the depth component derived from a ratio of a first function of the translational transformation between the first camera position and the second camera position, and a second function of the rotational transformation between the first camera position and the second camera position.

12. The system of claim 11, wherein the first function of the translational transformation between the first camera position and the second camera position is further based on a difference between a first term and a second term, the first term being based on a first component of the second two-dimensional joint position estimate, and the second term being based on a second component of the second two-dimensional joint position estimate.

13. The system of claim 12, wherein the first term is further based on a set of intrinsic parameters of the second camera.

14. The system of claim 13, wherein the first term is further based on a first component of the translational transformation between the first camera position and the second camera position.

15. The system of claim 10, wherein the generating of the first two-dimensional joint position estimate relative to the first camera position comprises utilizing a machine learning model, the model comprising:
an object detection backbone; and
a joint position estimation and camera parameter estimation block.

16. The system of claim 15, wherein the object detection backbone comprises:
a convolution block;
a Tucker block; and
a fused inverted bottleneck.

17. The system of claim 15, wherein the joint position estimation and camera parameter estimation block comprises:
an inverted residual block; and
a convolution block.

18. The system of claim 17, wherein the joint position estimation and camera parameter estimation block further comprises:
an average pooling block; and
a batch normalization block.

19. A system, comprising:
means for processing; and
a memory storing instructions which, when executed by the means for processing, cause performance of:
generating a first two-dimensional joint position estimate relative to a first camera in a first camera position;
generating a second two-dimensional joint position estimate relative to a second camera in a second camera position;
generating an estimated three-dimensional joint position based at least on:
a rotation transformation between the first camera position and the second camera position,
a generated translational transformation between the first camera position and the second camera position,
the first two-dimensional joint position estimate, and
the second two-dimensional joint position estimate; and
transmitting the generated three-dimensional joint position estimate.

20. The system of claim 19, wherein generating the three-dimensional joint position estimate comprises generating a depth component of the three-dimensional joint position estimate, the depth component derived from a ratio of a first function of the translational transformation between the first camera position and the second camera position, and a second function of the rotational transformation between the first camera position and the second camera position.
